(19) United States
(12) Patent Application Publication
(10) Pub. No.: US 2009/0158421 A1
(43) Pub. Date: Jun. 18, 2009

(54) Security Analysis Method

(75) Inventor: David Hunt, Surrey (GB)

Correspondence Address: NIXON & VANDERHYE, PC, 901 NORTH GLEBE ROAD, 11TH FLOOR, ARLINGTON, VA, 22203, US

(73) Assignee: Q SOFTWARE GLOBAL LIMITED, Dorking (GB)

(21) Appl. No.: 11/991,952

(22) PCT Filed: Sep. 12, 2006
(86) PCT No.: PCT/GB2006/003381

§ 371 Date: Mar. 13, 2008

(30) Foreign Application Priority Data
Sep. 16, 2005 (GB) 0518935.2

(51) Int. Cl. G06F 21/00

(52) U.S. Cl. 726/17

(57) ABSTRACT

A computer system comprising a receiving means for receiving an input of at least one user parameter a storage means for storing at least one template; a matching means for matching the at least one user parameter to a template; a locking means for locking the at least one user parameter to the matched template; and a providing means for providing an output of a user identification according to the matched template.

The present invention relates to a method of security analysis and a security tool.

Security analysis methods and tools are used to prevent unauthorised users gaining access to computer programs and data sources. Unauthorised access can lead to financial irregularities, for example because of user error or fraud. Recent corporate legislation such as the Sarbanes Oxley Act in the USA has increased the importance of protecting data both to prevent loss of profits within a business and legal action against a business for malpractice. The aim of security analysis methods and tools is to achieve a level of security referred to as “all doors closed”, whereby user access is fully controlled.

Existing devices and methods for ensuring the integrity of data systems require the input of several hundred parameters because parameters defining each user of the data system must be inputted. This process is time consuming and costly and often involves unnecessary duplication of input parameters. By defining each user of a data system individually the risk of a user gaining unauthorised access to a system is increased because of the increased risk of error in inputting the parameters which define a user.

Some existing devices and methods for ensuring integrity of data systems use menu based access. A user can only access limited menus and so accessible data is limited according to the parameters which have been inputted to define the user. However, a menu based access system increases the risk of unauthorised access because it does not prevent access through other routes, for example via function keys. Additionally, access to one data system element may provide access to other “hidden” or “associated” data system elements.

A “hidden” or “associated” data system element is typically an individual program or application that may not be obviously accessible to a user or may not be obvious as a program or application in its own right. An example of the latter might be the on-screen prompt for a user to confirm an action. This prompt may be a program or application in its own right to which access must be granted in order for a user to perform his or her function.

The present invention sets out to provide a security analysis method and tool which alleviates the problems described above.

In one aspect, the invention provides a security analysis method comprising the steps of;

receiving an input of at least one user parameter;

storing at least one template;

matching the at least one user parameter to a template;

locking the at least one user parameter to the matched template; and

providing an output of a user identification according to the matched template.

A “template” is a collection of user or program security attributes, usually defined by business group, role or function, and which may or may not have additional “rules” associated with it; or it is a collection of actual “rules”. A “rule” may be defined as a combination of one or more business groups, roles, or functions, which if the user has access to all of, would represent a security access conflict.

By “locking” it is understood that the matching of the template to the user parameters cannot be altered except by authorised users. By structuring the security analysis method to match inputted data parameters to templates the duplication of inputted data is reduced. The reduction in the volume of data that is received reduces the risk of error in user identification and so reduces the likelihood of fraudulent use of a system.

A data system can be analysed and updated using a method structured around templates, rather than individual data sets. This reduces the risk of error, the time and the cost of security analysis. The use of templates dispenses with the need for complex, error-prone and time-consuming allocation of individual user identification means.

Preferably the security analysis method further comprises unlocking the at least one user parameter from the matched template.

Locking and unlocking allows the template to be updated and/or new input parameters defining a user to be input. The security method can then automatically re-match a user's parameter/s to a new template and provide dynamic security analysis.

Preferably the template is unique.

Preferably, the template comprises at least one access path.

A unique template provides improved security. By matching a user to a unique template, which defines a user's access paths, the security of a data system is improved by controlling which users have access to different areas of a system. The access paths are traceable and can provide a trail to record which areas a user has accessed or has the potential to access.

Preferably, the security analysis method further comprises reporting the template and/or the access path matched to a user.

A report setting out the access available to a user provides a quick and easy way to analyse any weaknesses in the security of a data system.

Optionally, the security analysis method comprises matching of the at least one user parameter to rules associated with, or defined in, each template of two or more templates.

Preferably, the security analysis method further comprises conflict checking between the rules associated with, or defined in, each template, for two or more templates matched to identical user parameters.

Preferably, any conflict is recorded.

A user can be assigned to more than one template and if any conflict between the matched templates is checked and/or recorded the conflict can be avoided.

In a second embodiment, the invention provides a computer-readable carrier medium carrying computer readable instructions for performing the security analysis method.

Preferably, the carrier is, for example, a disc.

In a third embodiment, the invention provides a computer programmed to perform the security analysis method.

In a second aspect the invention provides a computer system comprising;

a receiving means for receiving an input of at least one user parameter;

a storage means for storing at least one template;

a matching means for matching the at least one user parameter to a template;

a locking means for locking the at least one user parameter to the matched template; and

a providing means for providing an output of a user identification according to the matched template.

Preferably the computer system further comprises an input means for inputting at least one user parameter.

More preferably, the input means is any one of a keyboard or a mouse.

Preferably, the computer system further comprises a reporting means for reporting the template matched to a user.

Preferably, the computer system further comprises an output means for outputting a user identification.

More preferably, the output means comprises a display means and/or a printer.

Preferably, the computer system further comprises unlocking means for unlocking the at least one user from the matched template.

Preferably, the computer system further comprises conflict checking means for checking for any conflict between two or more templates matched to identical user parameters.

The invention will now be described by way of example with reference to the accompanying diagrammatic drawings, in which:—

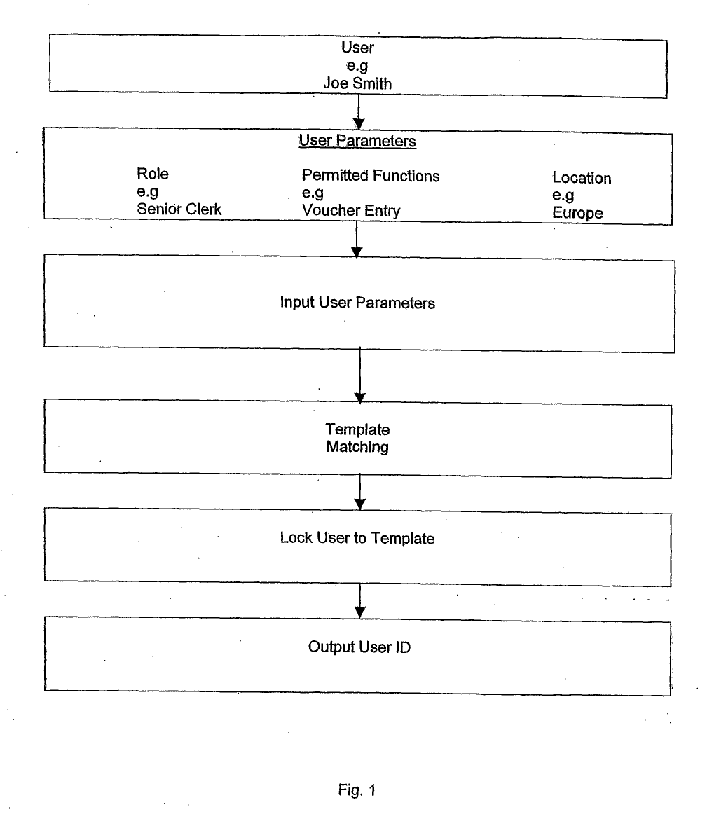

FIG. 1 is a flow chart illustrating a security analysis method according to the present invention; and

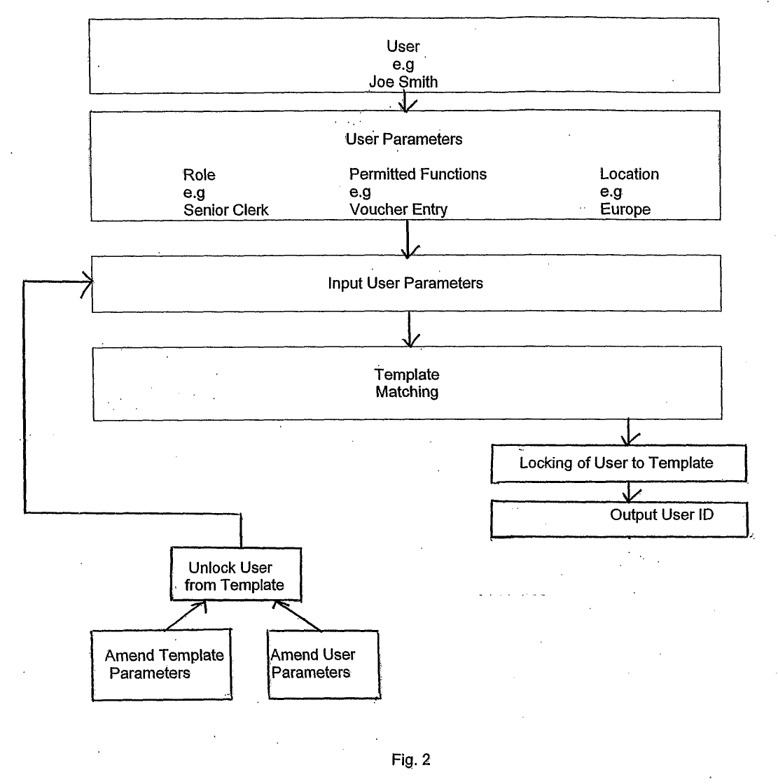

FIG. 2 is a flow chart illustrating the amendment of the user or template parameters illustrated in FIG. 1.

A security analysis method and computer system for carrying out the security analysis method according to the present invention comprises a data input means and storage means which stores multiple templates. Each template is unique and is defined according to parameters including, for example, tasks or business functions that a user is permitted to conduct; the data a user is authorised to access; the access privileges a user has when performing a specific task or business function, for example, read-only, update or delete; the “rules” that restrict a user performing multiple tasks or business functions. Each template that contains user based security attributes is made up of multiple access paths to define all possible routes a user is permitted to use to move between programs with the data system.

The security tool also comprises a template matching means and a locking means for locking the user's parameters to a matched template.

Referring to FIG. 1, in use within a business development environment comprising a data system, user parameters are allocated to a user. For example, the parameters are defined according to the user's location, the user's role and the tasks they are permitted to conduct. The user parameters are then inputted into the computer system. The user parameters are then matched to a template stored within the computer. Each template stored within the computer is unique and re-useable. The re-useable templates reduce the time, effort and cost involved in defining security, configuring and the on-going management of the computer system.

When a user has been matched to a template the matching is locked and a new matching cannot occur unless new user parameters are inputted or the parameters defining the template are amended. The template matched to a user defines the access a user has to the data system.

In a first embodiment the system can analyse and report all possible routes available to a user to move between programs within the computer system. For example, the system can analyse and report all short-cuts available to a user via on-screen menus, function keys or “low-level” commands. For example, an on-screen display shows a user name, the programs to which access is permitted and the programs to which access is available. The permitted access and available access often do not match and therefore this analysis allows for any “back-door” access to be identified.

Depending on the computer program to be analysed, the system can achieve this either by scanning the computer program source code, if available, to identify exits or calls to other computer programs, then tracing the source code of these subsequent associated or hidden programs for further exits or calls to other programs and so on; or if the source code is not available, by checking any program cross reference tables or data that may be available.

Having identified which programs a user has accessed or has the potential to access, the system provides a mechanism to modify the user's security or “lock down” a program to restrict the user's future access, using either dedicated security tables or security contained within the computer program itself.

In a second embodiment the computer system can analyse and report the template or templates matched to a user and the template parameters can be analysed to identify the access paths available to a user.

As shown in FIG. 2, if user parameters are amended then the amended parameters are inputted and the user template is unlocked to allow the template matching to be repeated. Similarly, if the template parameters are amended then the user template is unlocked to allow the user parameters to be inputted and the template matching to be repeated.

Where templates represent the security associated with particular business groups, roles or functions, a user can select a template related to a particular business group, role or function that he wishes to perform, and all the user security attributes defined within that template are applied to that user. A user can select more than one business group, role or function template at a time provided that the user is authorised to access such business group, role or function templates.

Each business group, role or function template is unique but more than one business group, role or function template can be matched to the parameters defining a user. A user can be allocated more than one business group, role or function template within a system. If the user is matched to more than one business group, role or function template then the computer system checks for conflict in the rules associated with the template. By checking and subsequently recording any conflict between multiple matched templates the system is able to identify incorrectly assigned user access and/or associated template parameters. The conflict can then be checked and user parameters or template parameters can be altered as shown in FIG. 2 or the conflict can be allowed.

When a user selects a particular business group, role or function, security should be applied as defined for that specific business group, role or function.

The above described embodiment has been given by way of example only, and the skilled reader will naturally appreciate that many variations could be made thereto without departing from the scope of the present invention.

1-21. (canceled)

22. A security analysis method comprising the steps of;
receiving an input of at least one user parameter; storing at least one template;
matching the at least one user parameter to a template;
locking the at least one user parameter to the matched template;
providing an output of a user identification according to the matched template; and
displaying the programs to which access is permitted and the programs to which access is available.

23. A security analysis method according to claim 22, further comprising the step of unlocking the at least one user parameter from the matched template.

24. A security analysis method according to claim 22, wherein the template is unique.

25. A security analysis method according to claim 22, wherein the template comprises at least one access path.

26. A security analysis method according to claim 22, further comprising the step of reporting the template and/or the access path matched to a user.

27. A security analysis method according to claim 22, further comprising the step of reporting the programs to which access is permitted and the programs to which access is available.

28. A security analysis method according to claim 22, wherein the at least one user parameter is matched to rules associated with, or defined in, each template of two or more templates.

29. A security analysis method according to claim 22, further comprising conflict checking between rules associated with, or defined in, each template of two or more templates matched to identical user parameters.

30. A security analysis method according to claim 29, wherein any conflict is recorded.

31. A computer-readable carrier medium carrying computer readable instructions for performing the security analysis method according to claim 22.

32. A computer-readable carrier medium according to claim 31, wherein the carrier is, for example, a disc.

33. A computer programmed to perform the security analysis method according to claim 22.

34. A computer system comprising;
a receiving means for receiving an input of at least one user parameter;
a storage means for storing at least one template;
a matching means for matching the at least one user parameter to a template;
a locking means for locking the at least one user parameter to the matched template;
a providing means for providing an output of a user identification according to the matched template; and
a display means for displaying the programs to which access is permitted and the programs to which access is available.

35. A computer system according to claim 34, further comprising an input means for inputting at least one user parameter.

36. A computer system according to claim 35, wherein the input means is any one of a keyboard or a mouse.

37. A computer system according to claim 34, further comprising a reporting means for reporting the template matched to a user and/or the access path matched to a user.

38. A computer system according to claim 34, further comprising a reporting means for reporting the programs to which access is permitted and the programs to which access is available.

39. A computer system according to claim 34, further comprising an output means for outputting a user identification.

40. A computer system according to claim 39, wherein the output means comprises a display means and/or a printer.

41. A computer system according to claim 34, further comprising an unlocking means for unlocking the at least one user from the matched template.

42. A computer system according to claim 34, further comprising conflict checking means for checking for any conflict between two or more templates matched to identical user parameters.
